(19) United States
(12) Patent Application Publication
(10) Pub. No.: US 2026/0212593 A1
(43) Pub. Date: Jul. 23, 2026

(54) PATH GUIDING USING NEURAL RADIANCE CACHING WITH DEFENSIVE RESAMPLED IMPORTANCE SAMPLING AND ADAPTIVE CANDIDATE ALLOCATION

(71) Applicant: DISNEY ENTERPRISES, INC., Burbank, CA (US)

(72) Inventors: Farnood SALEHI, Zürich (CH); Marios PAPAS, Opfikon (CH); Tiziano Andrea PORTENIER, Bern (CH); Marco MANZI, Zürich (CH); Alexander RATH, Saarbrücken (DE)

(21) Appl. No.: 19/458,312

(22) Filed: Jan. 23, 2026

Related U.S. Application Data
(60) Provisional application No. 63/748,857, filed on Jan. 23, 2025.

(51) Int. Cl. G06T 15/50; G06T 15/00; G06T 15/20

(52) U.S. Cl. CPC G06T 15/506; G06T 15/005; G06T 15/205; G06T 2210/24

(57) ABSTRACT

The present disclosure relates to computer-implemented path guiding in a rendering system. A sampling engine generates, at a scattering location on a lightpath, a set of candidate directions from source distributions and selects a direction using resampled importance sampling. The resampling may include defensive target construction in which a neural target derived from learned radiance estimates is combined with a defensive target derived from at least one source distribution, and the candidate directions are weighted and selected based on a fused target. In some embodiments, an optimized resampling candidate allocation (ORCA) module determines, for the scattering location, a candidate count specifying how many candidate directions are generated, wherein the candidate count is determined based on one or more rendering efficiency metrics that relate estimated variance reduction to computational cost. One or more learned radiance models may be trained using samples collected during rendering and evaluated during candidate evaluation.

### CROSS-REFERENCE TO RELATED APPLICATIONS

This application claims priority benefit to U.S. Provisional application titled “PATH GUIDING USING NEURAL RADIANCE CACHING WITH RESAMPLED IMPORTANCE SAMPLING,” filed on Jan. 23, 2025, and having Ser. No. 63/748,857. This related application is also hereby incorporated by reference in its entirety.

### TECHNICAL FIELD

Embodiments of the present disclosure relate generally to computer graphics and, more specifically, to techniques for performing path guiding using neural radiance caching with defensive resampled importance sampling and adaptive candidate allocation.

### BACKGROUND

In the field of computer graphics, rendering includes the process of generating an image of a scene based on a two-dimensional (2D) or three-dimensional (3D) representation of the scene. The 2D or 3D representation of the scene may include geometry, texture, lighting, and/or shading information describing the scene. In particular, the 2D or 3D representation may include information describing one or more light sources included in the scene.

One technique for calculating lighting effects in a rendered image of a scene includes generating multiple lightpaths associated with a virtual camera viewpoint. Each lightpath describes a trajectory that potentially connects the virtual camera to a light source included in the scene, and may include multiple scattering events or bounces based on the location of the virtual camera, the location of the one or more light sources, and the positions and surface characteristics associated with one or more objects included in the scene. Each interaction between a lightpath and one or more surfaces included in the scene may change the direction, color, and/or intensity of the reflected or scattered light and provided visual information associated with a location included in the rendered image.

Generating multiple lightpaths may be computationally expensive, as there may be millions or billions of possible lightpaths potentially connecting a virtual camera to each of multiple light sources via an arbitrary number of reflections or bounces. Further, many of the generated light paths may never reach a light source, even after multiple reflections or scattering events. These light paths do not generate any color or lighting information for locations within the scene, and do not contribute to pixel color values included in the final rendered image of the scene.

Monte Carlo path tracing is an example of a rendering technique that attempts to reduce the computational expense associated with generating lightpaths. Monte Carlo path tracing techniques stochastically sample a subset of all possible lightpaths, based on a determination of which lightpaths are more likely to reach one of one or more light sources included in a scene and therefore contribute to pixel values included in the final rendered image of the scene. Monte Carlo path tracing techniques may further include one or more path guiding techniques that inform the selection of lightpaths based on learned quantities related to the radiance distribution in a scene. Path guiding techniques may reduce the amount of variance or other error in a final rendered image of the scene.

Existing path guiding methods may employ parametric distributions or shallow models, e.g. tree-based parametric distributions, to describe the radiance characteristics of a scene. These parametric distributions may include simple mixtures of analytical distributions, such as Gaussian distributions or von Mises-Fisher distributions. These methods are trained independently for each spatial location in a scene and may overlook the global scene context, leading to variance and other errors in the rendered image.

Other existing path guiding methods may train a neural network representation of a scene, including radiance information associated with the scene. By training a single neural network representation for the entire scene, these techniques leverage all samples to train the representation, allowing the representation to learn the overall light distribution across the 3D scene. For example, a Neural Parametric Mixture (NPM) path guiding technique may train a Multilayer Perceptron Network (MLP) to predict parameters for a von Mises-Fisher parametric model. However, these methods are bound by the limitations of the underlying parametric model, and may not accurately estimate complex light distributions.

As the foregoing illustrates, what is needed in the art are more effective techniques for path guiding when generating lightpaths during rendering.

### SUMMARY

One embodiment of the present disclosure sets forth a technique for performing path guiding. The technique includes receiving a representation of a three-dimensional (3D) scene and a virtual camera location, and generating, based on at least the representation, a lightpath that originates at the virtual camera location and reaches a point included in the 3D scene. The technique further includes determining, for the point, a candidate count specifying a number of candidate directions to be considered for extending the lightpath from the point, wherein the candidate count is determined based at least on one or more rendering efficiency metrics, and generating, in accordance with the candidate count, a set of candidate directions for extending the lightpath from the point. The technique also includes extending the lightpath in a selected direction, and generating a two-dimensional (2D) rendering of the 3D scene based at least on the generated lightpath.

### BRIEF DESCRIPTION OF THE DRAWINGS

So that the manner in which the above recited features of the various embodiments can be understood in detail, a more particular description of the inventive concepts, briefly summarized above, may be had by reference to various embodiments, some of which are illustrated in the appended drawings. It is to be noted, however, that the appended drawings illustrate only typical embodiments of the inventive concepts and are therefore not to be considered limiting of scope in any way, and that there are other equally effective embodiments.

FIG. 1 illustrates a computer system configured to implement one or more aspects of various embodiments of the present invention.

FIG. 2 is a more detailed illustration of a sampling engine of FIG. 1, according to some embodiments.

FIG. 3 illustrates an example architecture and operation of a resampler included in the sampling engine of FIG. 2, according to some embodiments.

FIG. 4 illustrates an example implementation of an optimized resampling candidate allocation (ORCA) configured to determine a candidate count for resampled importance sampling, according to some embodiments.

FIG. 5A illustrates an example visualization of spatially varying candidate counts generated by the ORCA module of FIG. 4, according to some embodiments.

FIG. 5B illustrates a qualitative comparison of rendering results produced using different candidate allocation behaviors, according to some embodiments.

FIG. 6 is a flow diagram of method steps for performing path guiding using neural radiance caching with defensive resampled importance sampling and adaptive candidate allocation, according to some embodiments.

### DETAILED DESCRIPTION

### Overview

In the following description, numerous specific details are set forth to provide a more thorough understanding of the various embodiments. However, it will be apparent to one skilled in the art that the inventive concepts may be practiced without one or more of these specific details.

In some embodiments, a rendering system generates a two-dimensional (2D) image of a three-dimensional (3D) scene by simulating light transport using path tracing. The rendering system may receive a representation of the 3D scene and a virtual camera configuration, and may generate lightpaths that originate at the virtual camera location and propagate through the scene via successive scattering events. At each scattering event, the rendering system may determine one or more candidate directions in which a lightpath may be extended. The rendering system may include a sampling engine configured to generate candidate directions according to one or more source distributions, such as material-based distributions, light-directed distributions, uniform distributions, or learned guiding distributions that are directly sampleable. In some embodiments, the sampling engine generates a finite set of candidate directions and performs resampled importance sampling to select a single direction from the set based on estimated contribution to a rendered image.

In some embodiments, the resampling process uses a target function derived from predicted incident radiance. Incident radiance refers to light arriving at a point in the scene from a given direction. The rendering system may include a neural radiance training component that collects radiance samples during rendering and trains a machine learning model to predict incident radiance as a function of spatial location and direction. Because the predicted incident radiance is not required to be normalized or directly sampleable, the predicted values may be used to compute unnormalized target values for candidate directions during resampling.

To improve robustness when predicted incident radiance is inaccurate or incomplete, some embodiments implement defensive resampling. In defensive resampling, the rendering system combines a primary target function based on predicted incident radiance with a defensive target function derived from a source distribution used to generate the candidate directions. For each candidate direction, a modified target value may be computed based on weighted contributions from both target functions, with normalization performed over the candidate set. A direction may then be selected with probability proportional to the modified target values, ensuring that candidate directions remain selectable even when the predicted incident radiance is unreliable.

In addition to determining how candidate directions are weighted, some embodiments determine how many candidate directions are generated at a given point. The rendering system may determine a candidate count specifying a number of candidate directions to generate based at least on one or more rendering efficiency metrics, such as estimated variance reduction attributable to resampling and estimated computational cost. The candidate count may vary across the scene and along different lightpaths. In some embodiments, the rendering system collects statistical information during rendering, including sample contributions, resampling weights, and execution cost metrics. Based on this information, the rendering system may compute, for a given point or lightpath prefix, a candidate count that balances expected variance reduction against expected computational cost. The candidate count may be converted to an integer using stochastic rounding, and resampling may be bypassed when the candidate count falls below a threshold associated with resampling overhead.

The defensive resampling technique and the adaptive candidate allocation technique may operate together within the sampling engine. The adaptive candidate allocation technique may control how many candidate directions are generated, while the defensive resampling technique may control how those candidate directions are weighted and selected. Both techniques may be applied iteratively as lightpaths are generated and extended, and may be used with asynchronously trained machine learning models for predicting incident radiance.

Embodiments of the present disclosure may provide several technical improvements to computer-implemented rendering systems. For example, embodiments may improve the stability and correctness of path-guiding execution by modifying the internal operation of resampled importance sampling to incorporate defensive target evaluation. In conventional resampling approaches that rely on a single learned target, inaccurate or under-trained model outputs may assign negligible weight to valid transport directions, resulting in unstable estimators or missing illumination contributions. In contrast, the disclosed techniques compute, for each candidate direction, a modified target value that combines a learned radiance-based target with a target derived from a known source distribution. This combination is performed across the candidate set using normalized contributions, which ensures that candidate directions generated by the source distribution remain selectable. As a result, the sampling engine maintains full directional support while still biasing sampling toward directions predicted to contribute more strongly, thereby improving robustness during execution.

Further, embodiments improve computational efficiency by introducing runtime control over the number of candidate directions evaluated during resampled importance sampling. Rather than relying on a fixed candidate count applied uniformly across a scene, the disclosed techniques determine a candidate count at each scattering event based on rendering efficiency metrics that quantify an expected trade-off between variance reduction and computational cost. These metrics may include estimates of variance associated with source-based sampling, estimates of variance associated with resampling using learned targets, throughput values of a lightpath prefix, and execution cost indicators such as ray counts or model evaluation costs. By computing candidate counts from such metrics, the rendering system avoids excessive candidate generation in regions where resampling yields limited benefit, thereby reducing unnecessary neural model evaluations and ray traversal operations.

Additionally, embodiments improve utilization of processing resources by enabling spatially and path-dependent adaptation of resampling behavior within the rendering pipeline. The candidate count determination may vary across different regions of a 3D scene and along different lightpaths, allowing the sampling engine to concentrate computational effort in regions where learned guidance is effective and reduce effort where it is not. In some cases, when the computed candidate count falls below a threshold associated with resampling overhead, the rendering system may bypass resampled importance sampling and extend the lightpath using a direction sampled directly from a source distribution. This conditional execution path reduces control-flow overhead and computational waste while still allowing the system to continue collecting statistical information for future candidate count determinations.

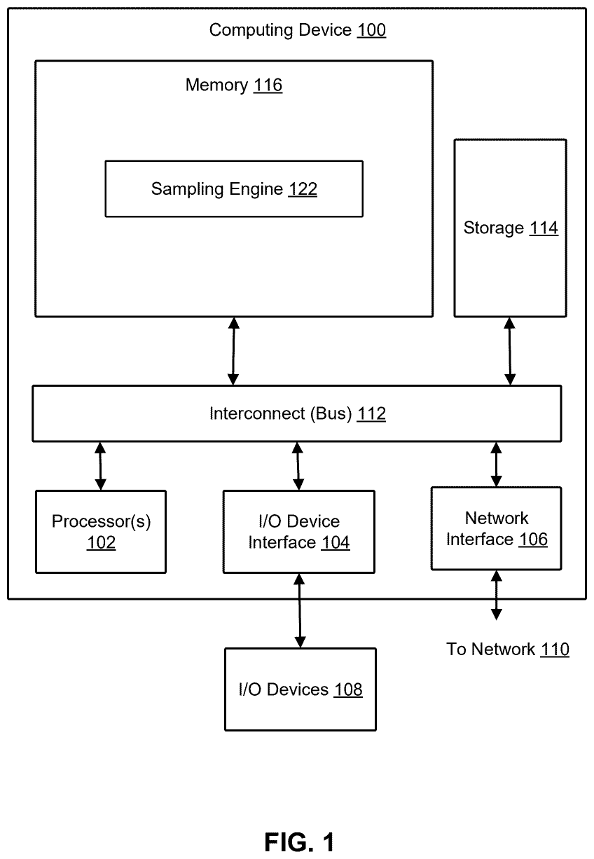

FIG. 1 illustrates a computing device 100 configured to implement one or more aspects of various embodiments of the present invention. In one embodiment, computing device 100 includes a desktop computer, a laptop computer, a smart phone, a personal digital assistant (PDA), tablet computer, or any other type of computing device configured to receive input, process data, and optionally display images, and is suitable for practicing one or more embodiments. Computing device 100 is configured to run a sampling engine 122 that resides in a memory 116.

It is noted that the computing device described herein is illustrative and that any other technically feasible configurations fall within the scope of the present disclosure. For example, multiple instances of sampling engine 122 could execute on a set of nodes in a distributed and/or cloud computing system to implement the functionality of computing device 100. In another example, sampling engine 122 could execute on various sets of hardware, types of devices, or environments to adapt sampling engine 122 to different use cases or applications. In a third example, sampling engine 122 could execute on different computing devices and/or different sets of computing devices.

In one embodiment, computing device 100 includes, without limitation, an interconnect (bus) 112 that connects one or more processors 102, an input/output (I/O) device interface 104 coupled to one or more input/output (I/O) devices 108, memory 116, a storage 114, and a network interface 106. Processor(s) 102 may be any suitable processor implemented as a central processing unit (CPU), a graphics processing unit (GPU), an application-specific integrated circuit (ASIC), a field programmable gate array (FPGA), an artificial intelligence (AI) accelerator, any other type of processing unit, or a combination of different processing units, such as a CPU configured to operate in conjunction with a GPU. In general, processor(s) 102 may be any technically feasible hardware unit capable of processing data and/or executing software applications. Further, in the context of this disclosure, the computing elements shown in computing device 100 may correspond to a physical computing system (e.g., a system in a data center) or may be a virtual computing instance executing within a computing cloud.

I/O devices 108 include devices capable of providing input, such as a keyboard, a mouse, a touch-sensitive screen, a microphone, and so forth, as well as devices capable of providing output, such as a display device or speaker. Additionally, I/O devices 108 may include devices capable of both receiving input and providing output, such as a touchscreen, a universal serial bus (USB) port, and so forth. I/O devices 108 may be configured to receive various types of input from an end-user (e_g, a designer) of computing device 100, and to also provide various types of output to the end-user of computing device 100, such as displayed digital images or digital videos or text. In some embodiments, one or more of I/O devices 108 are configured to couple computing device 100 to a network 110.

Network 110 is any technically feasible type of communications network that allows data to be exchanged between computing device 100 and external entities or devices, such as a web server or another networked computing device. For example, network 110 may include a wide area network (WAN), a local area network (LAN), a wireless (Wi-Fi) network, and/or the Internet, among others.

Storage 114 includes non-volatile storage for applications and data, and may include fixed or removable disk drives, flash memory devices, and CD-ROM, DVD-ROM, Blu-Ray, HD-DVD, or other magnetic, optical, or solid-state storage devices. Sampling engine 122 may be stored in storage 114 and loaded into memory 116 when executed.

Memory 116 includes a random-access memory (RAM) module, a flash memory unit, or any other type of memory unit or combination thereof. Processor(s) 102, I/O device interface 104, and network interface 106 are configured to read data from and write data to memory 116. Memory 116 includes various software programs that can be executed by processor(s) 102 and application data associated with said software programs, including sampling engine 122.

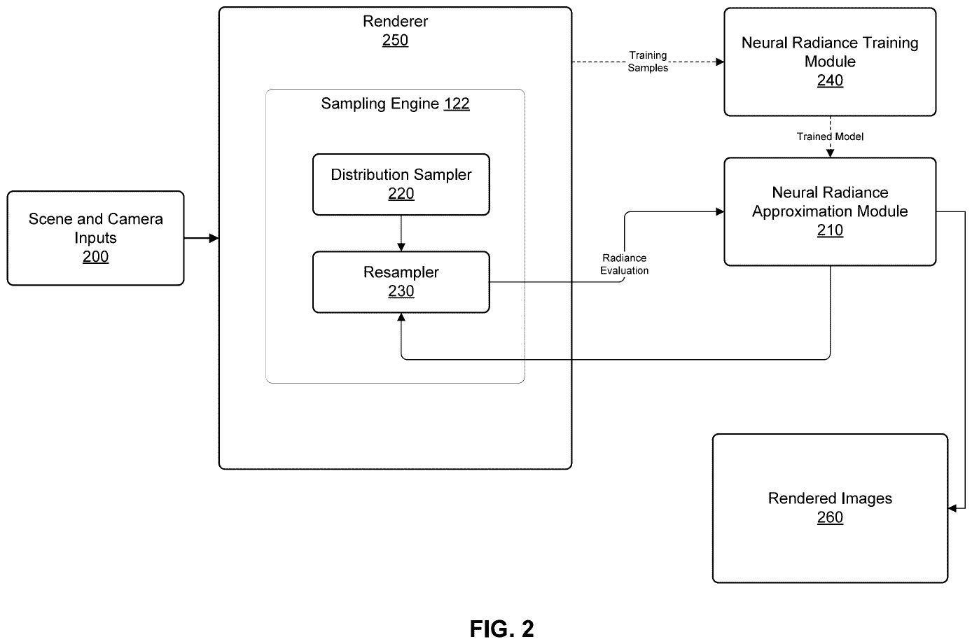

FIG. 2 illustrates, in greater detail, an example implementation of a renderer 250 with a sampling engine 122 usable with the rendering techniques described herein, according to some embodiments. As shown, scene and camera inputs 200 are provided to a renderer 250 that is configured to invoke sampling engine 122 during generation of one or more lightpaths through a three-dimensional (3D) scene.

In some embodiments, sampling engine 122 includes a distribution sampler 220 configured to generate, for a given scattering location on a lightpath, a set of candidate directions based on one or more source distributions, and a resampler 230 configured to select, from the set of candidate directions, a direction in which to extend the lightpath. In some embodiments, resampler 230 is configured to request one or more radiance evaluations from a neural radiance approximation module 210 and to incorporate outputs from neural radiance approximation module 210 when selecting the direction.

Neural radiance approximation module 210 is configured to evaluate a trained machine learning model that predicts radiance-related quantities, such as incident radiance, for candidate directions. In some embodiments, the trained model is provided by a neural radiance training module 240. Neural radiance training module 240 is configured to receive training samples from renderer 250, including radiance observations collected during rendering, and to train or update one or more parameters of the machine learning model. The trained model is then made available to neural radiance approximation module 210 for use during lightpath generation. In some embodiments, a neural radiance training module 240 is configured to receive training samples (e.g., radiance observations and associated features) from renderer 250, to train or update one or more machine learning model parameters based on the training samples, and to provide a trained model to neural radiance approximation module 210. Renderer 250 is configured to generate rendered image(s) 260 based at least on lightpaths generated using sampling engine 122.

Scene and camera inputs 200 include a representation of a 3D scene, where the 3D scene includes one or more objects and one or more light sources. The representation of the 3D scene includes geometry, texture, lighting, and/or shading information describing the scene. In particular, the representation may include information describing the one or more objects included in the 3D scene, such as position, size, shape, texture, surface normal, albedo, and roughness. The representation may also include information describing the one or more light sources included in the 3D scene, such as positions, intensities, or light color. In various embodiments, the representation of the 3D scene may include positions expressed in a world coordinate system associated with the 3D scene.

Scene and camera inputs 200 may also describe a viewpoint associated with a virtual camera, where the viewpoint includes a location associated with the virtual camera and an orientation associated with the virtual camera. In various embodiments, the location of the virtual camera may be expressed in the world coordinate system associated with the 3D scene, and the camera orientation may be expressed as, e.g., vertical and/or horizontal angular displacements from a neutral or baseline camera orientation.

In some embodiments, sampling engine 122 generates multiple lightpaths associated with the 3D scene in response to requests from renderer 250. A lightpath may originate at the virtual camera location defined by scene and camera inputs 200 and may proceed through the 3D scene until intersecting a surface or volume at a scattering location x. The scattering location x may include any point within the 3D scene at which a scattering event is evaluated, including a surface intersection, a volume interaction, or a boundary event. From the scattering location x, sampling engine 122 may determine a set of candidate outgoing directions via distribution sampler 220 and may select, via resampler 230, an outgoing direction in which to extend the lightpath. In some embodiments, resampler 230 selects the outgoing direction based at least in part on one or more radiance evaluations obtained from neural radiance approximation module 210. The lightpath may then be extended along the selected outgoing direction to one or more additional scattering locations within the 3D scene, until the lightpath exits the 3D scene, is terminated based on a termination criterion, or reaches a light source included in the 3D scene.

A generated lightpath that reaches a light source may connect the light source to the virtual camera directly or indirectly through one or more intermediate scattering locations. Renderer 250 is configured to generate rendered image(s) 260 based at least on lightpaths generated using sampling engine 122. In some embodiments, renderer 250 further provides training samples derived from the generated lightpaths to neural radiance training module 240, enabling asynchronous or iterative training of the machine learning model during rendering. Renderer 250 may determine a contribution of the lightpath to one or more image samples by accumulating radiometric terms associated with the lightpath, including, without limitation, emission at the light source, material response terms at scattering locations, transmittance through media, geometric terms, and a cumulative throughput corresponding to the lightpath prefix. Renderer 250 may update one or more pixels of rendered image(s) 260 based at least on the accumulated contribution of the lightpath and may optionally provide one or more training samples derived from the lightpath to neural radiance training module 240.

A generated lightpath from the virtual camera to scattering location x that later exits the 3D scene (possibly after multiple scattering or reflection events) without reaching a light source included in the 3D scene does not contribute to color or other characteristics associated with scattering location x. Therefore, when selecting an outgoing direction from which the lightpath is to leave a point, it is desirable to select the outgoing direction based on an amount of light reflected from the scattering location in the direction of the incoming lightpath. Sampling engine 122 samples directions ωᵢ at every point in the scene x with a distribution p that is (approximately) proportional to the amount of reflected light Lᵣ from ωᵢ at x towards the direction ωₒ that the lightpath came from:

$$p ( {ω}_{i} \vert x , {ω}_{o} ) ∝ {L}_{r} ( {ω}_{i} \vert x , {ω}_{o} ) \qquad Equation ( 1 )$$

The probability distribution p of Equation (1) will therefore favor outgoing directions ωᵢ that are associated with larger amounts of reflected light Lᵣ. In various embodiments, sampling engine 122 may evaluate the Lᵣ(ωᵢ|x, ωₒ) term included in Equation (1) by decomposing the term into the product of a BxDF f and the incident radiance Lᵢ:

$${L}_{r} ( {ω}_{i} \vert x , {ω}_{o} ) = f ( {ω}_{i} \vert x , {ω}_{o} ) {L}_{i} ( {ω}_{i} \vert x ) \qquad Equation ( 2 )$$

In Equation (2), BxDF f includes any bidirectional scattering distribution function known in the art, such as a Bidirectional Reflected Distribution Function (BRDF), a Bidirectional Transmittal Distribution Function (BTDF), or a Bidirectional Scattering-Surface Reflectance Distribution Function (BSSRDF). In various embodiments, the BxDF f may also incorporate one or more phase functions that describe the scattering of light incident on a volumetric participating media included in the 3D scene, such as smoke, fog, clouds, or fire. The BxDF f may be evaluated at inference time via a renderer, such as renderer 250 discussed below, based on information included in scene and camera inputs 200 that describes the various objects and surfaces included in a 3D scene.

The incident radiance term Lᵢ(ωᵢ|x) represents an amount of light incident on point x from a direction ωᵢ. The incident radiance term Lᵢ influences the amount of reflected light Lᵣ, as shown in Equation (2). In turn, the reflected light term Lᵣ influences the probability distribution p given by Equation (1). Consequently, the probability distribution p will, for a given BxDF f, favor directions ωᵢ from which greater amounts of incident light are received. For example, if multiple light sources included in the 3D scene directly illuminate a point x from different directions ωᵢ, the probability distribution p will favor a direction corresponding to a brighter light source included in the multiple light sources over a direction corresponding to a dimmer light source.

The incident radiance term Lᵢ(ωᵢ|x) is generally not known at inference time, prior to lightpath construction. Sampling engine 122 learns incident radiance characteristics associated with each point x included in the 3D scene via neural radiance approximation 210.

Neural radiance approximation 210 includes a neural network \hat{N} with parameters φ. Sampling engine 122 approximates Lᵢ(ωᵢ|x) with \hat{N}(ωᵢ|x, r(x), φ) by adjusting the parameters φ using backpropagation during inference as discussed below. Neural network \hat{N} of neural radiance approximation 210 also depends on r(x), where r(x) includes a vector of additional features, such as the surface normal, albedo, or roughness that depend on location x in the 3D scene and may be obtained from renderer 250 during path construction.

### Resampled Importance Sampling

In various embodiments, neural network \hat{N} included in neural radiance approximation 210 may be neither invertible nor normalized. Accordingly, sampling engine 122 may not be operable to sample directions directly from neural network \hat{N}. Rather than sampling directions directly from neural network \hat{N}, sampling engine 122 performs Resampled Importance Sampling (RIS) based on neural network \hat{N}. RIS enables sampling engine 122 to generate multiple samples that approximately follow the reflected radiance function Lᵣ(ωᵢ|x, ωₒ) from Equation (2) based on the incident radiance function Lᵢ(ωᵢ|x) as approximated by neural network \hat{N}(ωᵢ|x, r(x), φ). Specifically, an RIS target function T is given by:

$$T ( {ω}_{i} \vert x , r ( x ) , {ω}_{o} , ϕ ) = f ( {ω}_{i} \vert x , {ω}_{o} ) \hat{N} ( {ω}_{i} \vert x , r ( x ) , ϕ ) \qquad Equation ( 3 )$$

Distribution sampler 220 generates, for a point x included in the 3D scene, a set of M candidate directions v_{m′}k=1, . . . , M in which to potentially extend the lightpath, according to a known probability density function. For example, distribution sampler 220 may generate the set of candidate directions M based on a uniform distribution, a BxDF distribution, a cosine distribution, or a Next Event Estimation (NEE) distribution. For each candidate direction vₘ, distribution sampler 220 calculates an associated source probability density q(vₘ) based on an evaluation of the chosen probability density function. Distribution sampler 220 also calculates a resampling weight associated with the candidate direction vₘ:

$$resampling weight = T ( {v}_{m} ) / q ( {v}_{m} ) \qquad Equation ( 4 )$$

Distribution sampler 220 also calculates the sum W of all of the candidate directions' resampling weights. Distribution sampler 220 transmits the set of M candidate directions, the source probability densities q(vₘ) associated with each candidate direction, and the sum W of all of the candidate directions' resampling weights to resampler 230.

Resampler 230 re-samples, with replacement, N<M candidates from the set of candidate directions with probability q(vₘ)/T(vₘ)W, where T is the RIS target function given by Equation (3). In various embodiments, N may equal 1. Resampler 230 applies a correction factor W/M to quantities obtained based on the re-sampled directions, such as light intensities.

The correction factor reduces bias in the lightpath generation process that may lead to inaccuracies in rendered image 260 discussed below.

Sampling engine 122 may extend the generated lightpath based on the N resampled candidate directions. In various embodiments where N=1, sampling engine 122 extends the generated lightpath in the direction specified by the resampled candidate direction until the generated lightpath reaches another scattering location x included in the 3D scene, until the generated lightpath reaches a light source included in the 3D scene, or until the generated lightpath exits the 3D scene. A scattering location x included in the 3D scene may be located on a surface depicted in the 3D scene, or may be located within a volumetric element included in the 3D scene, e.g., smoke, clouds, fog, or fire. Consequently, the scattering location x may be located at any position within the 3D scene. If the generated lightpath reaches another scattering location x included in the 3D scene, sampling engine 122 repeats the above sampling and resampling processes at the new scattering location x and continues constructing the lightpath.

In various embodiments, sampling engine 122 may terminate the generation of a lightpath that has not reached a light source after a predetermined number of intersections with multiple scattering locations x included in the 3D scene. If a generated lightpath reaches a light source included in the 3D scene that does not itself reflect light from one or more additional light sources included in the 3D scene, the generated lightpath is complete, and connects the light source to the virtual camera from which the generated lightpath originated. Sampling engine 122 transmits the completed lightpath to renderer 250. Sampling engine 122 may further generate additional light paths as described above, beginning at the virtual camera location and initially extending into different regions of the 3D scene.

Renderer 250 may be any computer graphics renderer that is suitable to generate, based on multiple received lightpaths, a 2D depiction of a 3D scene as viewed from a virtual camera position, where a description of the 3D scene and the viewpoint of the virtual camera are included in scene and camera inputs 200. In various embodiments, renderer 250 may begin at one end of a received lightpath corresponding to the virtual camera. Renderer 250 may traverse the received lightpath from the virtual camera to the light source, calculating values describing lighting effects associated with the direct or indirect interaction of light from the light source with one or more scattering locations x included in the 3D scene that lie along the lightpath. For example, for a scattering location x included in the 3D scene and lying along the lightpath, renderer 250 may determine a color value associated with scattering location x. In various embodiments, the color determination may be based on a direction ωᵢ from which incoming direct or indirect light reaches scattering location x, a direction ωₒ in which scattered and/or reflected light leaves scattering location x towards the virtual camera, and one or more surface or media characteristics associated with scattering location x. As discussed above, the one or more surface or media characteristics may include texture, surface normal, albedo, and roughness characteristics received in scene and camera inputs 200. Based on the determined color values associated with multiple points included in the 3D scene, renderer 250 generates rendered image 260.

Rendered image 260 includes a 2D representation of the 3D scene as viewed from the virtual camera viewpoint, where the virtual scene and virtual camera are described in scene and camera inputs 200. In various embodiments, rendered image 260 may include a 2D raster image having a rectangular arrangement of pixels. Each of the pixels may include one or more associated values, such as color or transparency values.

In various embodiments, the 3D scene and virtual camera viewpoint included in scene and camera inputs 200 may represent a single frame of multiple frames included in a video sequence depicting the 3D scene. In these embodiments, rendered image 260 may include a 2D representation of the 3D scene corresponding to the 3D scene and virtual camera viewpoint included in scene and camera inputs 200.

### Training the Neural Radiance Approximation

As described above, the neural network \hat{N}(ωᵢ|x, r(x), φ) included in neural radiance approximation 210 estimates the incident radiance at a point x received from an incidence direction ωᵢ, based on at least parameters φ. For a given completed lightpath received from sampling engine 122, renderer 250 may generate ground truth incident radiance values for one or more points included in the received lightpath, based on known light transport functions, such as BxDF functions. In various embodiments, sampling engine 122 may include one or more loss functions (not shown), where a value associated with a loss function represents a difference between a ground truth incident radiance value calculated by renderer 250 and an estimated incident radiance value estimated by neural radiance approximation 210. For example, a loss function may include a mean-squared error (MSE) evaluation of differences between ground truth and estimated incident radiance values. Sampling engine 122 may modify one or more parameters φ included in neural network \hat{N} via backpropagation, based on the one or more loss function values.

In various embodiments, sampling engine 122 may initialize one or more parameters φ included in neural network \hat{N} to predetermined default values, and periodically modify the parameters φ during inference based on the one or more loss function values. In other embodiments, sampling engine 122 may initialize one or more parameters φ included in neural network \hat{N} to predetermined default values, and repeatedly modify the parameters φ for a predetermined number of iterations as sampling engine 122 generates completed lightpaths. After the predetermined number of iterations have completed, the parameters φ included in neural network \hat{N} may remain fixed while sampling engine 122 generates subsequent lightpaths. In various embodiments where scene and camera inputs 200 includes multiple frames of a video sequence depicting the 3D scene, sampling engine 122 may continue to use the modified parameters φ included in neural network \hat{N} when generating lightpaths associated with subsequent frames of the video sequence.

### Separating Light Transport

In various embodiments, sampling engine 122 may decompose the incident radiance term Lᵢ(ωᵢ|x) of Equation (2) into a sum of the direct illumination and the indirect illumination incident on a point x:

$${L}_{i} ( {ω}_{i} \vert x ) = {L}_{i , direct} ( {ω}_{i} \vert x ) + {L}_{i , indirect} ( {ω}_{i} \vert x ) \qquad Equation ( 5 )$$

In these embodiments, neural radiance approximation 210 may include separate neural networks to estimate each of indirect incident radiance L_{i, direct} (ωᵢ|x) and direct incident radiance L_{i, indirect} (ωᵢ|x) included in Equation (5), rather than a single neural network \hat{N} as discussed above. In these embodiments, each separate neural network learns and specializes on a specific type of light transport, i.e., direct or indirect lighting, and distribution sampler 220 may include multiple transport-specific candidate sampling functions. In various embodiments, the incidence radiance at a point x may be further decomposed into more components, including but not limited to, caustic light transport, illumination from volume interactions, or illumination from a discrete number of indirect light bounces in a lightpath.

Combination with Neural Radiance Caches

In various embodiments, a neural radiance training module 240 may learn an approximation \hat{M} of the integrated reflected radiance into a direction ωₒ from a point x:

$${L}_{r} ( {ω}_{o} , x ) = {\int }_{Ω} f ( {ω}_{i} \vert x , {ω}_{o} ) {L}_{i} ( {ω}_{i} \vert x ) d {ω}_{i} \qquad Equation ( 6 )$$

In various embodiments, approximation \hat{M} represents a neural radiance cache and may include a neural network similar in operation to \hat{N} described above. For a given combination of a point x included in a 3D scene and a direction ωₒ from which a lightpath reaches point x, sampling engine 122 may determine whether neural radiance training module 240 stores, or can generate via evaluation of \hat{M}, an approximation of integrated reflected radiance into direction ωₒ from point x. This approximation may be based on one or more prior lightpath generation iterations in which sampling engine 122 generated one or more lightpath segments beyond point x, and in which at least some of those lightpath segments contributed radiance associated with the 3D scene.

In some embodiments, sampling engine 122 may terminate, truncate, or otherwise modify lightpath generation at point x by utilizing \hat{M}(x, ωₒ) to determine an estimated contribution associated with continuing the lightpath, rather than generating additional lightpath segments beyond point x. Similar to training \hat{N}, sampling engine 122 may train \hat{M} based on one or more target radiance values associated with point x and direction ωₒ, including values computed from completed or partially completed lightpaths. In some embodiments, sampling engine 122 may additionally train \hat{M} using samples that incorporate lookups into the neural radiance cache, including temporal-difference-style updates in which an estimate produced by \hat{M} at a subsequent scattering location is used to update \hat{M} at an earlier scattering location. These neural radiance training techniques may reduce an amount of computation performed to extend lightpaths to completion relative to configurations that compute contributions solely from fully traced lightpaths.

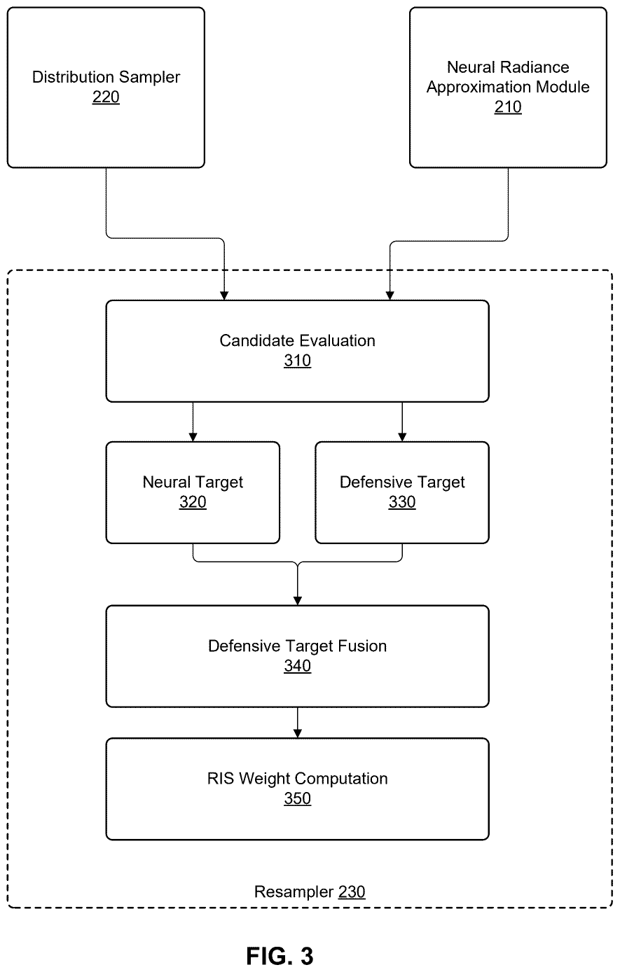

FIG. 3 illustrates, in greater detail, an example internal architecture and operation of resampler 230, according to some embodiments. As shown, resampler 230 receives candidate directions generated by distribution sampler 220 and radiance-related information provided by neural radiance approximation module 210. Resampler 230 is configured to evaluate the candidate directions and to select a direction in which to extend a lightpath based on resampled importance sampling with defensive target construction. In some embodiments, candidate directions generated by distribution sampler 220 are provided to a candidate evaluation stage 310. Candidate evaluation stage 310 is configured to process each candidate direction in conjunction with scene-dependent information, including, without limitation, a spatial location of a scattering event, a direction from which a lightpath arrives at the scattering event, material response information, and radiance estimates obtained from neural radiance approximation module 210. Candidate evaluation stage 310 may compute intermediate values associated with each candidate direction that are used to construct one or more target functions.

As illustrated in FIG. 3, candidate evaluation stage 310 produces, for each candidate direction, a neural target 320 and a defensive target 330. Neural target 320 may represent an unnormalized target value derived at least in part from predicted incident radiance generated by neural radiance approximation module 210. The neural target 320 may additionally incorporate material response terms, geometric factors, and throughput values associated with a lightpath prefix leading to the scattering location. Defensive target 330 may represent a target value derived from a source distribution associated with distribution sampler 220, such as a probability density value corresponding to the candidate direction under the source distribution. Resampler 230 may include a defensive target fusion stage 340 configured to combine neural target 320 and defensive target 330 to generate a fused target value for each candidate direction. In some embodiments, defensive target fusion stage 340 computes the fused target value using normalized contributions of the neural target and the defensive target across the set of candidate directions. A weighting parameter may be applied to control a relative influence of the neural target and the defensive target, thereby ensuring that candidate directions generated by the source distribution remain selectable even when neural radiance predictions are inaccurate or incomplete.

Following defensive target fusion 340, resampler 230 may include a resampled importance sampling (RIS) weight computation stage 350. RIS weight computation stage 350 is configured to compute, for each candidate direction, a resampling weight based on the fused target value and a probability density associated with the candidate direction under the source distribution. Based on the computed resampling weights, resampler 230 may probabilistically select a single candidate direction from the set of candidate directions to extend the lightpath. In some embodiments, resampler 230 performs the operations illustrated in FIG. 3 for each scattering event encountered during lightpath generation. The operations may be repeated iteratively as lightpaths are extended through the 3D scene. Although FIG. 3 depicts specific functional blocks, the arrangement and separation of these blocks are illustrative and non-limiting, and one or more blocks may be combined, reordered, or implemented as a single process or as multiple processes without departing from the scope of the disclosed embodiments.

In some embodiments, neural radiance approximation module 210 provides, for each candidate direction ωᵢ, a predicted incident radiance value expressed as N_{Θ}(x, ωᵢ), where N_{Θ} denotes a learned function parameterized by a neural network with parameters Θ, and x denotes a scattering location in the scene.

Based on the predicted incident radiance, candidate evaluation stage 310 computes a neural target value \hat{p}₁ for each candidate direction ωᵢ. The neural target value represents an unnormalized estimate of the expected contribution of extending the current light path from the scattering location x along direction ωᵢ, taking into account the accumulated throughput of the light path prefix and the material response at the scattering location. In accordance with the paper, the neural target value is computed as:

$$\text{?} ( {ω}_{i} \vert {ω}_{o} , \overline{x} ) = \frac{1}{3} {\sum }_{c ∈ \{ R , G , B \}} {T}_{c} ( \overline{x} ) {B}_{c} ( {ω}_{i} \vert x , {ω}_{o} ) {N}_{Θ , c} ( {ω}_{i} , x )$$

where x̅ denotes the light path prefix terminating at location x, T_{c}(x̅) denotes the throughput of the prefix path for color channel c, B_{c}(ωᵢ|x, ωₒ) denotes a material response term (including a cosine term where applicable) evaluated for outgoing direction ωₒ and incoming direction ωᵢ, and N_{Θ,c} denotes the predicted incident radiance for color channel c.

Because the neural target value \hat{p}₁ is unnormalized and may be inaccurate in certain regions of the scene, candidate evaluation stage 310 further computes a defensive target value \hat{p}₂ for each candidate direction ωᵢ, where the defensive target is defined as the source distribution used to generate candidate directions:

$$\text{?} ( {ω}_{i} ) = q ( {ω}_{i} \vert x )$$

Defensive target fusion stage 340 computes a fused target value

$${\hat{p}}_{i}^{′}$$

for each candidate direction ωᵢ by combining the neural target and the defensive target using a weighted mixture that preserves unbiasedness of resampled importance sampling. In accordance with the paper, the fused target value is computed as:

$$\text{?} = α \frac{1}{C} \frac{\text{?} ( {ω}_{i} )}{{\sum }_{j = 1}^{C} \text{?} ( {ω}_{j} ) {q}^{- 1} ( {ω}_{j} )} + ( 1 - α ) \frac{1}{C} \frac{\text{?} ( {ω}_{i} )}{{\sum }_{j = 1}^{C} \text{?} ( {ω}_{j} ) {q}^{- 1} ( {ω}_{j} )}$$

where C denotes the number of candidate directions generated at the scattering location, α∈[0,1] controls a relative influence of the neural target and the defensive target, and the summations are performed over the set of candidate directions.

Resampler 230 selects a candidate direction ωₛ from the candidate set according to probabilities proportional to the fused target values

$${\hat{p}}_{i}^{′} .$$

After a candidate direction is selected, resampler 230 computes a resampled importance sampling weight W_{RIS} in accordance with resampled importance sampling as follows:

$${W}_{RIS} = \frac{1}{C \text{?} ( {ω}_{s} )} {\sum }_{i = 1}^{C} \text{?} ( {ω}_{i} ) {q}^{- 1} ( {ω}_{i} )$$

The sampling engine then extends the light path by generating a ray segment from the scattering location x in the selected direction ωₛ. The ray segment is traced through the scene until intersecting another surface or participating medium, reaching a light source, exiting the scene, or satisfying a termination criterion. Radiometric quantities, including throughput and material response terms, are updated for subsequent scattering events.

The operations described with respect to FIG. 3 may be repeated at successive scattering locations as light paths are generated through the three-dimensional scene. The functional blocks illustrated in FIG. 3 represent logical operations and are non-limiting, and equivalent mathematical operations may be implemented using different software or hardware configurations.

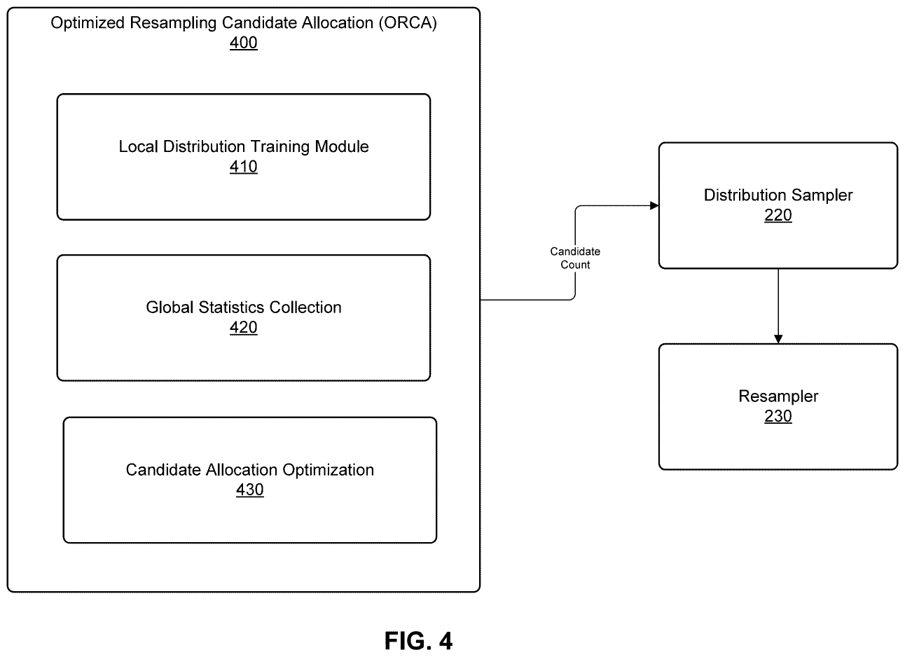

FIG. 4 illustrates an example implementation of an optimized resampling candidate allocation (ORCA) module 400, according to some embodiments. ORCA module 400 is configured to determine, for one or more scattering locations encountered during path tracing, a candidate count specifying a number of candidate directions to be generated by distribution sampler 220 for use by resampler 230. The candidate count determined by ORCA module 400 may vary across different regions of a three-dimensional (3D) scene and along different lightpaths, enabling spatially and path-dependent control of resampled importance sampling behavior. As shown, ORCA module 400 includes a local distribution training module 410, a global statistics collection module 420, and a candidate allocation optimization module 430. In some embodiments, ORCA module 400 operates in conjunction with sampling engine 122 and receives statistical information collected during rendering, including information associated with sampling efficiency, estimator variance, and computational cost.

Local distribution training module 410 may be configured to train or update one or more sampling distributions that are defined locally for the scene, such as distributions associated with a spatial region, a set of nearby scattering locations, a surface patch, a volumetric region, a cell of a spatial data structure, or any other localized partitioning of path vertices. The local distribution training module 410 may generate or update parameters of such local sampling distributions based on radiance samples collected during rendering, including, without limitation, incident radiance observations, path throughput values, material properties at scattering locations, and/or directions associated with prior scattering events. In some embodiments, updates to local sampling distributions may be performed incrementally during rendering as additional samples are collected, periodically after a number of samples or iterations, or asynchronously with respect to ray traversal.

In some embodiments, local distribution training module 410 trains a guiding distribution that is directly sampleable and that approximates incident radiance and/or a measure of directional importance at a scattering location. “Directly sampleable” in this context refers to a distribution from which distribution sampler 220 can efficiently generate candidate directions without requiring inversion of a learned model or evaluation of an unknown normalization constant. The guiding distribution may be represented using any technically feasible form, such as a histogram, a parametric distribution, a mixture model, a tree-based directional representation, or another lightweight representation suitable for low-cost sampling.

The trained local distribution may then be provided to distribution sampler 220 and used as one of multiple source distributions for generating candidate directions. In some embodiments, distribution sampler 220 selects among source distributions using a fixed selection probability, a heuristic, or a multiple-importance-sampling strategy, and generates candidate directions from the selected source distribution(s) for subsequent evaluation and resampling by resampler 230.

Global statistics collection module 420 may be configured to collect, store, and aggregate statistical information across multiple lightpaths, scattering events, pixels, and/or rendering iterations. In some embodiments, global statistics collection module 420 receives statistical records generated during path construction and resampling and computes summary values (e.g., running averages, second-moment estimates, histograms, or other aggregate statistics) that characterize sampling effectiveness and computational overhead. Such statistical information may include, without limitation, per-sample contribution values to one or more pixels, estimates of variance (or second moments) associated with sampling from a source distribution, estimates of variance (or second moments) associated with resampled importance sampling using learned targets, throughput values associated with lightpath prefixes (including per-channel throughput components), and measures of resampling behavior such as resampling weights, normalization terms, or acceptance probabilities.

Global statistics collection module 420 may further collect execution cost metrics, including, without limitation, the number of candidate directions generated and evaluated, the number of neural model evaluations performed, ray traversal counts, shading evaluations, or elapsed time measurements associated with one or more stages of the sampling engine. In some embodiments, the collected statistical information is indexed or accumulated using a spatial data structure, a per-material grouping, a per-bounce grouping, a per-pixel grouping, or a combination thereof, and is provided to candidate allocation optimization module 430 to determine candidate counts based on rendering efficiency objectives.

Candidate allocation optimization module 430 may be configured to determine, for a given scattering location (or corresponding lightpath prefix), a candidate count specifying how many candidate directions distribution sampler 220 should generate for evaluation and potential resampling by resampler 230. In some embodiments, the candidate count is determined based on one or more rendering efficiency metrics and an optimization objective that balances an expected reduction in estimator variance against an expected increase in computational cost attributable to generating and evaluating additional candidate directions. The expected reduction in variance may be estimated, for example, from statistics that characterize a difference between variance obtained when sampling using one or more source distributions and variance obtained when using resampled importance sampling guided by learned radiance estimates. The expected computational cost may be estimated based on execution cost metrics associated with candidate generation, target evaluation (including neural model evaluation), and/or ray traversal and shading operations performed per candidate direction.

In some embodiments, the determined candidate count varies across different regions of the scene and across different lightpath prefixes, and may be computed as a real-valued quantity that is converted to an integer candidate count using stochastic rounding. In some embodiments, when the computed candidate count fails to satisfy a condition indicating that resampled importance sampling is expected to improve rendering efficiency (e.g., when the candidate count is below a threshold associated with resampling overhead or when learned targets perform worse than source sampling), candidate allocation optimization module 430 indicates that resampled importance sampling is to be disabled at the scattering location and distribution sampler 220 generates candidate directions using a default sampling configuration.

In some embodiments, ORCA module 400 provides the determined candidate count to distribution sampler 220, which generates the specified number of candidate directions and provides those candidate directions to resampler 230. The candidate count may be recomputed periodically, continuously, or on a per-scattering-location basis as rendering progresses.

In some embodiments, candidate allocation optimization module 430 determines candidate counts by optimizing a global rendering efficiency objective that relates estimator variance to computational cost. For a given candidate count function c(x) defined over scattering locations x, an efficiency objective may be expressed as

$$c *= arg {max}_{c} ( {\sum }_{{p}_{x}} C [ 〈 {I}_{{p}_{x}} ; c 〉 ] ) {( {\sum }_{{p}_{x}} V [ 〈 {I}_{{p}_{x}} ; c 〉 ] )}^{- 1}$$

where C[⋅] denotes an expected computational cost and V[⋅] denotes an expected estimator variance. In this context, pₓ denotes a set of lightpath prefixes that terminate at scattering locations x, and [symbol] Iₚ_{ₓ}; c [symbol] denotes an image-sample estimator (or pixel contribution estimator) computed using a candidate-count function c(⋅) along those prefixes. Such an objective defines the goal of selecting candidate counts that improve rendering efficiency by reducing image noise relative to the computation expended. For example, the cost term C[⋅] may capture work performed to generate and evaluate candidate directions, including neural model evaluations and ray traversal/shading operations, while the variance term V[⋅] may capture noise in the resulting pixel estimates produced from the sampled lightpaths. Rather than minimizing variance or cost independently, the objective explicitly balances the expected image variance remaining in the rendered image against the expected computational effort required to produce that image, aggregated across the relevant lightpath prefixes and corresponding pixel estimators.

In some embodiments, candidate allocation optimization module 430 derives a local optimality condition for a candidate count at a given scattering location x̅ by differentiating the efficiency objective with respect to c(x̅), yielding

$${V}_{I} \frac{\partial }{\partial c ( \overline{x} )} C [ 〈 {L}_{γ} ( \overline{x} ) ; c ( \overline{x} ) 〉 ] + {C}_{I} {T}^{2} ( \overline{x} ) \frac{\partial }{\partial c ( \overline{x} )} V [ 〈 {L}_{r} ( \overline{x} ) ; c ( \overline{x} ) 〉 ] = 0$$

where T(x̅) denotes a throughput associated with a lightpath prefix terminating at x̅, and V_{I} and C_{I} denote global variance and cost normalization terms, respectively. This condition describes a point at which increasing the number of candidate directions at location x̅ no longer produces a sufficient reduction in variance to justify the additional computational cost. The throughput term T(x̅) scales the importance of variance reduction at that location based on how strongly contributions from that point affect the final image.

In some embodiments, candidate allocation optimization module 430 models the variance of a resampled importance sampling (RIS) estimator as a function of the candidate count c. In particular, the variance of an RIS estimator that selects a single direction from c candidates may be approximated as a convex combination of the variance obtained when sampling from a source distribution and the variance obtained when sampling from the target distribution, expressed as

$$V [ 〈 {L}_{r} ; c 〉 ] = \frac{1}{c} {V}_{s} [ 〈 {L}_{r} 〉 ] + ( 1 - \frac{1}{c} ) {V}_{r} [ 〈 {L}_{r} 〉 ]$$

where Vₛ denotes variance associated with source-based sampling and Vᵣ denotes variance associated with resampled importance sampling. This equation may model how estimator variance changes as the number of candidate directions increases. When the candidate count is small, variance is dominated by the source sampling strategy. As the candidate count increases, the estimator increasingly reflects the behavior of resampled importance sampling, which typically exhibits lower variance. The equation provides a continuous approximation of this transition.

To account for the computational overhead introduced by generating and evaluating multiple candidates, candidate allocation optimization module 430 further models the expected computational cost of RIS as a function of the candidate count. In some embodiments, the cost is modeled as a linear function

$$C [ 〈 Lr ; c 〉 ] = cK 0 + K 1 + C [ 〈 Lr 〉 ]$$

where K₀ represents costs that scale linearly with the number of candidates (such as candidate generation and target evaluation), K₁ represents fixed overhead costs incurred once per resampling operation, and C[ [symbol] Lᵣ [symbol] ] denotes the expected cost of evaluating the final selected sample. This model reflects the observation that resampling overhead increases with the number of candidates, even though only a single final direction is traced further.

Based on the variance model and the cost model, candidate allocation optimization module 430 determines a candidate count that optimizes overall rendering efficiency by balancing variance reduction against computational expense. In some embodiments, this balance is expressed by an efficiency objective that aggregates variance and cost contributions across the image and across lightpath prefixes. Solving the resulting optimization condition yields a real-valued optimal candidate count for a scattering location x, expressed as

$$c ( \overline{x} ) = \sqrt{\frac{{T}^{2} ( \overline{x} ) ( {V}_{S} [ 〈 {L}_{r} ( \overline{x} ) 〉 ] - {V}_{t} [ 〈 {L}_{r} ( \overline{x} ) 〉 ] )}{( {V}_{I} / {C}_{I} ) {K}_{0}}}$$

where T(x̅) denotes the throughput associated with the lightpath prefix terminating at x̅, and (V_{I}/C_{I})K₀ is a cost-related normalization that reflects the relative impact of evaluating additional candidate directions. This expression estimates how many candidate directions should be generated at location x̅ by comparing the expected reduction in estimator variance achievable through resampling against the expected increase in computational cost. Scattering locations associated with higher throughput and a larger expected variance reduction benefit are therefore assigned larger candidate counts, whereas locations with low throughput or limited variance improvement are assigned fewer candidate directions.

Because candidate counts must be integer-valued during execution, candidate allocation optimization module 430 may convert the real-valued candidate count c*(x̅) into an integer using stochastic rounding. In some embodiments, when the computed candidate count c(x̅) falls below a threshold associated with resampling overhead, ORCA module 400 may disable resampled importance sampling for the corresponding scattering location and instruct distribution sampler 220 to generate candidate directions using a default sampling configuration. For example, RIS may be disabled when

$$c ( \overline{x} ) \leq \sqrt{\frac{{K}_{1}}{{K}_{0}}} .$$

In some embodiments, when the computed candidate count c(x) falls below a threshold associated with resampling overhead, ORCA module 400 may disable resampled importance sampling for the corresponding scattering location and instruct distribution sampler 220 to generate candidate directions using a default sampling configuration.

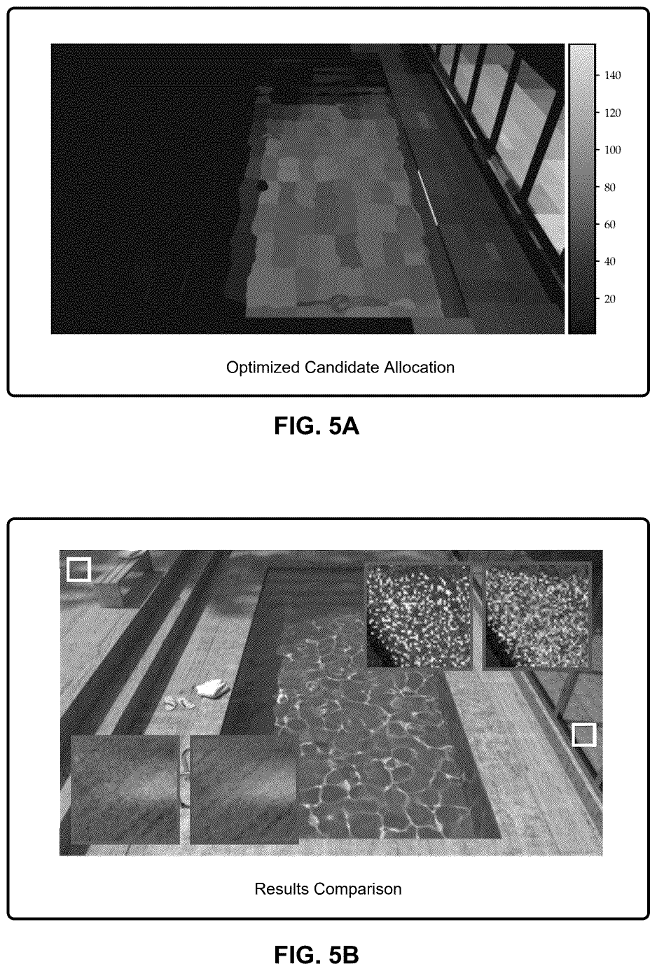

FIG. 5A illustrates an example visualization of candidate allocation determined by optimized resampling candidate allocation (ORCA) module 400, according to some embodiments. In the illustrated embodiment, ORCA module 400 outputs, for a plurality of scattering locations x in a three-dimensional (3D) scene, corresponding candidate counts that are provided as a “candidate count” control signal to distribution sampler 220. Distribution sampler 220 is configured to generate, for a given scattering location, a number of candidate directions consistent with the candidate count, and to provide the generated candidate directions to resampler 230. The visualization of FIG. 5A depicts spatial variation in the candidate counts across the scene, where different visual intensities represent different candidate counts and higher intensities correspond to larger numbers of candidate directions generated by distribution sampler 220 for evaluation by resampler 230.

FIG. 5A illustrates that candidate counts determined by ORCA module 400 are not uniform across the scene. In some embodiments, candidate allocation optimization module 430 assigns larger candidate counts in regions where resampled importance sampling performed by resampler 230 is expected to provide greater variance reduction relative to source-based sampling by distribution sampler 220. Such regions may include, without limitation, regions associated with indirect illumination, specular reflection, caustic transport, occlusion boundaries, or other scene configurations that yield higher estimator variance when fewer candidate directions are evaluated. Conversely, candidate allocation optimization module 430 assigns smaller candidate counts in regions where additional candidate evaluations are expected to provide limited benefit.

In some embodiments, the candidate allocation illustrated in FIG. 5A is determined using statistical information collected by global statistics collection module 420, including throughput values associated with lightpath prefixes and variance-related quantities associated with estimates produced when resampler 230 selects candidate directions. Local distribution training module 410 may train or update one or more locally defined guiding distributions that are used by distribution sampler 220 as source distributions for candidate generation, and the collected statistics may reflect performance of those source distributions as well as performance of resampling using targets derived from neural radiance approximation module 210. Based on such information, ORCA module 400 adaptively allocates candidate counts to concentrate computational effort where it is expected to reduce variance more effectively while limiting overhead where additional candidate evaluation is not expected to materially improve the estimator.

FIG. 5B illustrates a qualitative comparison of rendering results associated with different candidate allocation behaviors, according to some embodiments. In the illustrated embodiment, a rendered image produced by renderer 250 is shown along with magnified regions that highlight differences in noise characteristics and convergence behavior attributable to candidate allocation. In some embodiments, distribution sampler 220 generates candidate directions using a candidate count determined by ORCA module 400, and resampler 230 selects an outgoing direction based on evaluating the candidate directions using resampled importance sampling. The magnified regions illustrate that, in portions of the image where ORCA module 400 assigns larger candidate counts, the resulting image exhibits reduced variance relative to configurations that apply a fixed or uniform candidate count across the scene.

In some embodiments, the differences illustrated in FIG. 5B are more pronounced in image regions associated with indirect illumination or other high-variance transport paths. In such regions, using a larger candidate count enables resampler 230 to more reliably select candidate directions associated with higher contribution, including candidate directions whose target values depend at least in part on radiance estimates generated by neural radiance approximation module 210. Conversely, in regions where the expected benefit of resampling is lower, ORCA module 400 may assign smaller candidate counts, thereby reducing the number of candidate evaluations performed by resampler 230 and reducing computation performed by distribution sampler 220, without materially degrading rendered image quality.

FIGS. 5A and 5B illustrate that ORCA module 400 provides a runtime control mechanism that modifies operation of distribution sampler 220 and resampler 230 on a spatially varying basis. FIG. 5A illustrates internal allocation of candidate counts that influence how many candidate directions are evaluated at different scattering locations, and FIG. 5B illustrates resulting effects on output produced by renderer 250, including reduced noise in selected regions while avoiding unnecessary computation in other regions.

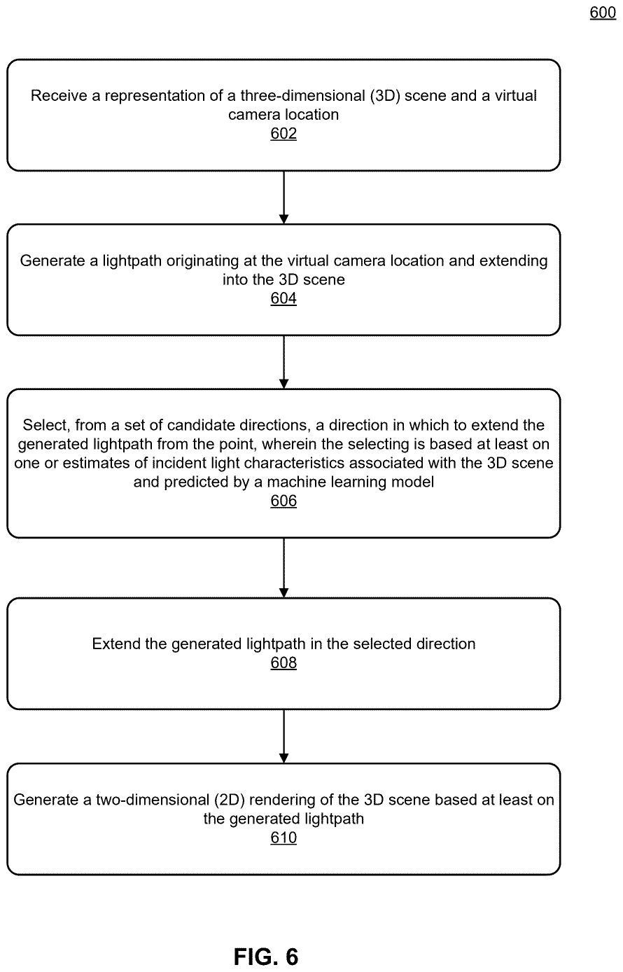

FIG. 6 illustrates an example method 600 for performing path guiding in a computer-implemented rendering system, according to some embodiments. The method 600 may be performed by one or more components of sampling engine 122 in conjunction with renderer 250 and related modules described herein. Although the steps of method 600 are illustrated in a particular order, in other embodiments one or more steps may be performed in a different order, combined, repeated, or omitted, without departing from the scope of the disclosed techniques.

At step 602, the rendering system receives a representation of a three-dimensional (3D) scene and a virtual camera location. In some embodiments, the representation of the 3D scene includes geometric data, material properties, lighting information, and other scene parameters usable by renderer 250 and sampling engine 122. The virtual camera location defines an origin and orientation for generating lightpaths corresponding to image samples.

At step 604, the rendering system generates a lightpath that originates at the virtual camera location and extends into the 3D scene. In some embodiments, sampling engine 122 initializes the lightpath with a direction corresponding to a pixel sample and propagates the lightpath through the scene until a first scattering location is reached. The lightpath may represent a sequence of ray segments corresponding to simulated light transport between the scene and the virtual camera.

At step 606, the rendering system selects, from a set of candidate directions, a direction in which to extend the generated lightpath from a scattering location. In some embodiments, distribution sampler 220 generates the set of candidate directions based on one or more source distributions, and resampler 230 selects one candidate direction using resampled importance sampling. The selecting may be based at least in part on one or more estimates of incident light characteristics associated with the 3D scene, including radiance estimates predicted by neural radiance approximation module 210 and, in some embodiments, additional target values derived from defensive resampling techniques. The selection step may further incorporate a candidate count determined by optimized resampling candidate allocation (ORCA) module 400.

At step 608, the rendering system extends the generated lightpath in the selected direction. In some embodiments, sampling engine 122 traces a ray segment in the selected direction to a subsequent scattering location, a light source, or a termination condition. The lightpath may accumulate throughput, material response terms, and other radiometric quantities as it is extended.

At step 610, the rendering system generates a two-dimensional (2D) rendering of the 3D scene based at least on the generated lightpath. In some embodiments, renderer 250 computes one or more pixel contributions based on radiance accumulated along the lightpath and combines those contributions with other samples to produce a rendered image. The method 600 may be repeated for multiple lightpaths and pixel samples to generate a final rendered image with reduced variance and improved convergence characteristics.

The embodiments described herein provide a rendering system in which path guiding is performed using resampled importance sampling that incorporates learned radiance estimates while maintaining robustness through defensive target construction. By combining a neural target derived from predicted incident radiance with a defensive target derived from one or more source distributions, the sampling engine 122 ensures that candidate directions generated by analytically defined sampling strategies remain eligible for selection. This integration modifies the internal weighting and selection logic of the resampler 230, enabling learned radiance information to influence sampling decisions without requiring the learned model to define a normalized or directly sampleable distribution.

The embodiments further describe an optimized resampling candidate allocation mechanism that dynamically determines how many candidate directions are generated at individual scattering locations during lightpath construction. Candidate counts are computed based on rendering efficiency metrics that relate expected variance reduction to computational cost, and may vary spatially across a scene and along different lightpaths. This adaptive allocation reduces unnecessary candidate evaluation in low-benefit regions while increasing sampling effort where resampled importance sampling is expected to provide greater variance reduction.

Clause 1. A computer-implemented method for performing path guiding, the computer-implemented method comprising: receiving a representation of a three-dimensional (3D) scene and a virtual camera location; generating, based on at least the representation, a lightpath that originates at the virtual camera location and reaches a point included in the 3D scene; determining, for the point, a candidate count specifying a number of candidate directions to be considered for extending the lightpath from the point, wherein the candidate count is determined based at least on one or more rendering efficiency metrics; generating, in accordance with the candidate count, a set of candidate directions for extending the lightpath from the point; extending the lightpath in a selected direction; and generating a two-dimensional (2D) rendering of the 3D scene based at least on the generated lightpath.

Clause 2. The computer-implemented method of clause 1, wherein selecting the direction comprises: computing, for each candidate direction in the set of candidate directions, a first target value based at least on one or more estimates of incident light characteristics predicted by the machine learning model; computing, for each candidate direction, a second target value based at least on a source distribution used to generate the set of candidate directions; combining the first target value and the second target value for each candidate direction to produce a combined target value; and selecting the direction from the set of candidate directions based at least on the combined target value.

Clause 3. The computer-implemented method of any of the clauses 1 or 2, wherein the one or more rendering efficiency metrics comprise: an image variance metric associated with at least a portion of the 2D rendering; an image cost metric associated with rendering the at least the portion of the 2D rendering; and a variance difference metric associated with sampling at the point that characterizes a difference between a variance obtained when selecting directions using a source distribution and a variance obtained when selecting directions using a target based on the machine learning model, and wherein determining the candidate count is based at least on the image variance metric, the image cost metric, and the variance difference metric.

Clause 4. The computer-implemented method of any of the clauses 1 through 3, wherein determining the candidate count comprises determining the candidate count as a function that increases with an expected reduction in variance attributable to sampling using the target based on the machine learning model and decreases with an expected computational cost attributable to evaluating additional candidate directions.

Clause 5. The computer-implemented method of any of the clauses 1 through 4, wherein determining the candidate count further comprises weighting the expected reduction in variance based at least in part on a throughput of a path prefix associated with the point.

Clause 6. The computer-implemented method of any of the clauses 1 through 5, wherein the variance difference metric is determined based at least in part on statistics derived from resampled importance sampling that compare second-moment estimates obtained using the source distribution and the target based on the machine learning model.

Clause 7. The computer-implemented method of any of the clauses 1 through 6, wherein the image cost metric represents a total rendering cost accumulated over a plurality of samples and includes costs that scale linearly with the candidate count and costs that are independent of the candidate count.

Clause 8. The computer-implemented method of any of the clauses 1 through 7, wherein determining the candidate count comprises: in response to determining that the candidate count fails to satisfy a condition indicating that resampled importance sampling is expected to improve rendering efficiency, determining that resampled importance sampling is to be disabled at the point.

Clause 9. The computer-implemented method of any of the clauses 1 through 8, wherein determining the candidate count further comprises: generating a non-integer candidate count; and converting the non-integer candidate count to an integer candidate count using stochastic rounding.

Clause 10. One or more non-transitory computer-readable media storing instructions that, when executed by one or more processors, cause the one or more processors to perform the steps of: receiving a representation of a three-dimensional (3D) scene and a virtual camera location; generating, based on at least the representation, a lightpath that originates at the virtual camera location and reaches a point included in the 3D scene; determining, for the point, a candidate count specifying a number of candidate directions to be considered for extending the lightpath from the point, wherein the candidate count is determined based at least on one or more rendering efficiency metrics; generating, in accordance with the candidate count, a set of candidate directions for extending the lightpath from the point; extending the lightpath in a selected direction; and generating a two-dimensional (2D) rendering of the 3D scene based at least on the generated lightpath.

Clause 11. The one or more non-transitory computer-readable media of clause 10, wherein selecting the direction comprises: computing, for each candidate direction in the set of candidate directions, a first target value based at least on one or more estimates of incident light characteristics predicted by the machine learning model; computing, for each candidate direction, a second target value based at least on a source distribution used to generate the set of candidate directions; combining the first target value and the second target value for each candidate direction to produce a combined target value; and selecting the direction from the set of candidate directions based at least on the combined target value.

Clause 12. The one or more non-transitory computer-readable media of clauses 10 or 11, wherein the one or more rendering efficiency metrics comprise: an image variance metric associated with at least a portion of the 2D rendering; an image cost metric associated with rendering the at least the portion of the 2D rendering; and a variance difference metric associated with sampling at the point that characterizes a difference between a variance obtained when selecting directions using a source distribution and a variance obtained when selecting directions using a target based on the machine learning model, and wherein determining the candidate count is based at least on the image variance metric, the image cost metric, and the variance difference metric.

Clause 13. The one or more non-transitory computer-readable media of any of the clauses 10 through 12, wherein determining the candidate count comprises determining the candidate count as a function that increases with an expected reduction in variance attributable to sampling using the target based on the machine learning model and decreases with an expected computational cost attributable to evaluating additional candidate directions.

Clause 14. The one or more non-transitory computer-readable media of any of the clauses 10 through 13, wherein determining the candidate count further comprises weighting the expected reduction in variance based at least in part on a throughput of a path prefix associated with the point.

Clause 15. The one or more non-transitory computer-readable media of any of the clauses 10 through 14, wherein the variance difference metric is determined based at least in part on statistics derived from resampled importance sampling that compare second-moment estimates obtained using the source distribution and the target based on the machine learning model.

Clause 16. The one or more non-transitory computer-readable media of any of the clauses 10 through 15, wherein the image cost metric represents a total rendering cost accumulated over a plurality of samples and includes costs that scale linearly with the candidate count and costs that are independent of the candidate count.

Clause 17. The one or more non-transitory computer-readable media of any of the clauses 10 through 16, wherein determining the candidate count comprises: in response to determining that the candidate count fails to satisfy a condition indicating that resampled importance sampling is expected to improve rendering efficiency, determining that resampled importance sampling is to be disabled at the point.

Clause 18. The one or more non-transitory computer-readable media of any of the clauses 10 through 17, wherein determining the candidate count further comprises: generating a non-integer candidate count; and converting the non-integer candidate count to an integer candidate count using stochastic rounding.

Clause 19. A system comprising: one or more memories storing instructions; and one or more processors for executing the instructions to: receive a representation of a three-dimensional (3D) scene and a virtual camera location; generate, based on at least the representation, a lightpath that originates at the virtual camera location and reaches a point included in the 3D scene; determine, for the point, a candidate count specifying a number of candidate directions to be considered for extending the lightpath from the point, wherein the candidate count is determined based at least on one or more rendering efficiency metrics; generate, in accordance with the candidate count, a set of candidate directions for extending the lightpath from the point; extend the lightpath in a selected direction; and generate a two-dimensional (2D) rendering of the 3D scene based at least on the generated lightpath.

Clause 20. The system of clause 19, wherein selecting the direction comprises: computing, for each candidate direction in the set of candidate directions, a first target value based at least on one or more estimates of incident light characteristics predicted by the machine learning model; computing, for each candidate direction, a second target value based at least on a source distribution used to generate the set of candidate directions; combining the first target value and the second target value for each candidate direction to produce a combined target value; and selecting the direction from the set of candidate directions based at least on the combined target value.

Any and all combinations of any of the claim elements recited in any of the claims and/or any elements described in this application, in any fashion, fall within the contemplated scope of the present invention and protection.

The descriptions of the various embodiments have been presented for purposes of illustration but are not intended to be exhaustive or limited to the embodiments disclosed. Many modifications and variations will be apparent to those of ordinary skill in the art without departing from the scope and spirit of the described embodiments.

Aspects of the present embodiments may be embodied as a system, method or computer program product. Accordingly, aspects of the present disclosure may take the form of an entirely hardware embodiment, an entirely software embodiment (including firmware, resident software, micro-code, etc.) or an embodiment combining software and hardware aspects that may all generally be referred to herein as a “module,” a “system,” or a “computer.” In addition, any hardware and/or software technique, process, function, component, engine, module, or system described in the present disclosure may be implemented as a circuit or set of circuits. Furthermore, aspects of the present disclosure may take the form of a computer program product embodied in one or more computer readable medium(s) having computer readable program code embodied thereon.

Any combination of one or more computer readable medium(s) may be utilized. The computer readable medium may be a computer readable signal medium or a computer readable storage medium. A computer readable storage medium may be, for example, but not limited to, an electronic, magnetic, optical, electromagnetic, infrared, or semiconductor system, apparatus, or device, or any suitable combination of the foregoing. More specific examples (a non-exhaustive list) of the computer readable storage medium would include the following: an electrical connection having one or more wires, a portable computer diskette, a hard disk, a random access memory (RAM), a read-only memory (ROM), an erasable programmable read-only memory (EPROM or Flash memory), an optical fiber, a portable compact disc read-only memory (CD-ROM), an optical storage device, a magnetic storage device, or any suitable combination of the foregoing. In the context of this document, a computer readable storage medium may be any tangible medium that can contain or store a program for use by or in connection with an instruction execution system, apparatus, or device.

Aspects of the present disclosure are described above with reference to flowchart illustrations and/or block diagrams of methods, apparatus (systems) and computer program products according to embodiments of the disclosure. It will be understood that each block of the flowchart illustrations and/or block diagrams, and combinations of blocks in the flowchart illustrations and/or block diagrams, can be implemented by computer program instructions. These computer program instructions may be provided to a processor of a general-purpose computer, special purpose computer, or other programmable data processing apparatus to produce a machine. The instructions, when executed via the processor of the computer or other programmable data processing apparatus, enable the implementation of the functions/acts specified in the flowchart and/or block diagram block or blocks. Such processors may be, without limitation, general purpose processors, special-purpose processors, application-specific processors, or field-programmable gate arrays.

The flowchart and block diagrams in the figures illustrate the architecture, functionality, and operation of possible implementations of systems, methods and computer program products according to various embodiments of the present disclosure. In this regard, each block in the flowchart or block diagrams may represent a module, segment, or portion of code, which comprises one or more executable instructions for implementing the specified logical function(s). It should also be noted that, in some alternative implementations, the functions noted in the block may occur out of the order noted in the figures. For example, two blocks shown in succession may, in fact, be executed substantially concurrently, or the blocks may sometimes be executed in the reverse order, depending upon the functionality involved. It will also be noted that each block of the block diagrams and/or flowchart illustration, and combinations of blocks in the block diagrams and/or flowchart illustration, can be implemented by special purpose hardware-based systems that perform the specified functions or acts, or combinations of special purpose hardware and computer instructions.

While the preceding is directed to embodiments of the present disclosure, other and further embodiments of the disclosure may be devised without departing from the basic scope thereof, and the scope thereof is determined by the claims that follow.

What is claimed is:

1. A computer-implemented method for performing path guiding, the computer-implemented method comprising:
receiving a representation of a three-dimensional (3D) scene and a virtual camera location;
generating, based on at least the representation, a lightpath that originates at the virtual camera location and reaches a point included in the 3D scene;
determining, for the point, a candidate count specifying a number of candidate directions to be considered for extending the lightpath from the point, wherein the candidate count is determined based at least on one or more rendering efficiency metrics;
generating, in accordance with the candidate count, a set of candidate directions for extending the lightpath from the point;
extending the lightpath in a selected direction; and
generating a two-dimensional (2D) rendering of the 3D scene based at least on the generated lightpath.

2. The computer-implemented method of claim 1, wherein selecting the direction comprises:
computing, for each candidate direction in the set of candidate directions, a first target value based at least on one or more estimates of incident light characteristics predicted by the machine learning model;
computing, for each candidate direction, a second target value based at least on a source distribution used to generate the set of candidate directions;
combining the first target value and the second target value for each candidate direction to produce a combined target value; and
selecting the direction from the set of candidate directions based at least on the combined target value.

3. The computer-implemented method of claim 1, wherein the one or more rendering efficiency metrics comprise:
an image variance metric associated with at least a portion of the 2D rendering;
an image cost metric associated with rendering the at least the portion of the 2D rendering; and
a variance difference metric associated with sampling at the point that characterizes a difference between a variance obtained when selecting directions using a source distribution and a variance obtained when selecting directions using a target based on the machine learning model,
and wherein determining the candidate count is based at least on the image variance metric, the image cost metric, and the variance difference metric.

4. The computer-implemented method of claim 3, wherein determining the candidate count comprises determining the candidate count as a function that increases with an expected reduction in variance attributable to sampling using the target based on the machine learning model and decreases with an expected computational cost attributable to evaluating additional candidate directions.

5. The computer-implemented method of claim 4, wherein determining the candidate count further comprises weighting the expected reduction in variance based at least in part on a throughput of a path prefix associated with the point.

6. The computer-implemented method of claim 3, wherein the variance difference metric is determined based at least in part on statistics derived from resampled importance sampling that compare second-moment estimates obtained using the source distribution and the target based on the machine learning model.

7. The computer-implemented method of claim 3, wherein the image cost metric represents a total rendering cost accumulated over a plurality of samples and includes costs that scale linearly with the candidate count and costs that are independent of the candidate count.

8. The computer-implemented method of claim 1, wherein determining the candidate count comprises:
in response to determining that the candidate count fails to satisfy a condition indicating that resampled importance sampling is expected to improve rendering efficiency, determining that resampled importance sampling is to be disabled at the point.

9. The computer-implemented method of claim 1, wherein determining the candidate count further comprises:
generating a non-integer candidate count; and
converting the non-integer candidate count to an integer candidate count using stochastic rounding.

10. One or more non-transitory computer-readable media storing instructions that, when executed by one or more processors, cause the one or more processors to perform the steps of:
receiving a representation of a three-dimensional (3D) scene and a virtual camera location;
generating, based on at least the representation, a lightpath that originates at the virtual camera location and reaches a point included in the 3D scene;
determining, for the point, a candidate count specifying a number of candidate directions to be considered for extending the lightpath from the point, wherein the candidate count is determined based at least on one or more rendering efficiency metrics;
generating, in accordance with the candidate count, a set of candidate directions for extending the lightpath from the point;
extending the lightpath in a selected direction; and
generating a two-dimensional (2D) rendering of the 3D scene based at least on the generated lightpath.

11. The one or more non-transitory computer-readable media of claim 10, wherein selecting the direction comprises:
computing, for each candidate direction in the set of candidate directions, a first target value based at least on one or more estimates of incident light characteristics predicted by the machine learning model;
computing, for each candidate direction, a second target value based at least on a source distribution used to generate the set of candidate directions;
combining the first target value and the second target value for each candidate direction to produce a combined target value; and
selecting the direction from the set of candidate directions based at least on the combined target value.

12. The one or more non-transitory computer-readable media of claim 10, wherein the one or more rendering efficiency metrics comprise:
an image variance metric associated with at least a portion of the 2D rendering;
an image cost metric associated with rendering the at least the portion of the 2D rendering; and
a variance difference metric associated with sampling at the point that characterizes a difference between a variance obtained when selecting directions using a source distribution and a variance obtained when selecting directions using a target based on the machine learning model,
and wherein determining the candidate count is based at least on the image variance metric, the image cost metric, and the variance difference metric.

13. The one or more non-transitory computer-readable media of claim 12, wherein determining the candidate count comprises determining the candidate count as a function that increases with an expected reduction in variance attributable to sampling using the target based on the machine learning model and decreases with an expected computational cost attributable to evaluating additional candidate directions.

14. The one or more non-transitory computer-readable media of claim 13, wherein determining the candidate count further comprises weighting the expected reduction in variance based at least in part on a throughput of a path prefix associated with the point.

15. The one or more non-transitory computer-readable media of claim 12, wherein the variance difference metric is determined based at least in part on statistics derived from resampled importance sampling that compare second-moment estimates obtained using the source distribution and the target based on the machine learning model.

16. The one or more non-transitory computer-readable media of claim 12, wherein the image cost metric represents a total rendering cost accumulated over a plurality of samples and includes costs that scale linearly with the candidate count and costs that are independent of the candidate count.

17. The one or more non-transitory computer-readable media of claim 10, wherein determining the candidate count comprises:
in response to determining that the candidate count fails to satisfy a condition indicating that resampled importance sampling is expected to improve rendering efficiency, determining that resampled importance sampling is to be disabled at the point.

18. The one or more non-transitory computer-readable media of claim 10, wherein determining the candidate count further comprises:
generating a non-integer candidate count; and
converting the non-integer candidate count to an integer candidate count using stochastic rounding.

19. A system comprising:
one or more memories storing instructions; and
one or more processors for executing the instructions to:
receive a representation of a three-dimensional (3D) scene and a virtual camera location;
generate, based on at least the representation, a lightpath that originates at the virtual camera location and reaches a point included in the 3D scene;
determine, for the point, a candidate count specifying a number of candidate directions to be considered for extending the lightpath from the point, wherein the candidate count is determined based at least on one or more rendering efficiency metrics;
generate, in accordance with the candidate count, a set of candidate directions for extending the lightpath from the point;
extend the lightpath in a selected direction; and
generate a two-dimensional (2D) rendering of the 3D scene based at least on the generated lightpath.

20. The system of claim 19, wherein selecting the direction comprises:
computing, for each candidate direction in the set of candidate directions, a first target value based at least on one or more estimates of incident light characteristics predicted by the machine learning model;
computing, for each candidate direction, a second target value based at least on a source distribution used to generate the set of candidate directions;
combining the first target value and the second target value for each candidate direction to produce a combined target value; and
selecting the direction from the set of candidate directions based at least on the combined target value.
